(19) United States
(12) Patent Application Publication
(10) Pub. No.: US 2020/0007609 A1
(43) Pub. Date: Jan. 2, 2020

(54) IMAGE OUTPUT SYSTEM, SERVER APPARATUS, AND NON-TRANSITORY COMPUTER READABLE MEDIUM STORING PROGRAM

(71) Applicant: FUJI XEROX CO., LTD., Tokyo (JP)

(72) Inventor: Kenji KAWASE, Kanagawa (JP)

(73) Assignee: FUJI XEROX CO., LTD., Tokyo (JP)

(21) Appl. No.: 16/442,563

(22) Filed: Jun. 17, 2019

(30) Foreign Application Priority Data
Jun. 27, 2018 (JP) 2018-121492

(51) Int. Cl. H04L 29/08; H04L 29/06

(52) U.S. Cl. CPC H04L 67/06; H04L 67/306; H04L 63/08

(57) ABSTRACT

An image output system includes a section that manages identification information for identifying a terminal apparatus and a target file as a target of an image output in correlation with each other, a section that acquires identification information of the terminal apparatus and designation information for designating an image output apparatus from the terminal apparatus, and a section that transmits the target file correlated with the identification information of the terminal apparatus, which has been acquired from the terminal apparatus to the image output apparatus designated by the designation information acquired from the terminal apparatus.

### CROSS-REFERENCE TO RELATED APPLICATIONS

This application is based on and claims priority under 35 USC 119 from Japanese Patent Application No. 2018-121492 filed Jun. 27, 2018.

### BACKGROUND

### (i) Technical Field

The present invention relates to an image output system, a server apparatus, and a non-transitory computer readable medium storing a program.

### (ii) Related Art

JP2016-091424A discloses an image forming apparatus as follows. In a case where the image forming apparatus detects an attempt to access a remote user interface, the image forming apparatus determines whether or not address information of the remote user interface to which the attempt of the access has been performed coincides with address information of a remote user interface, which has been written in a tag in a short-range wireless communication. In a case where the image forming apparatus determines that these pieces of address information coincide with each other, the image forming apparatus permits the access to the remote user interface.

JP6257147B discloses a printing system as follows. A terminal apparatus instructs a printing service device to perform printing without specifying an image processing apparatus which is to perform printing. The printing service device transmits a command of writing preservation information regarding a preservation place of a printing job in a short-range wireless communication unit of the terminal apparatus. The image processing apparatus acquires the preservation information written in the short-range wireless communication unit of the terminal apparatus and performs the printing job.

JP2016-046627A discloses an image forming apparatus as follows. The image forming apparatus selects one from plural application services, as a selection application service and generates specific data for specifying the selection application service. In a case where a transmission request of the specific data is received from the terminal apparatus, the image forming apparatus transmits the specific data to the terminal apparatus in a short-range wireless communication.

### SUMMARY

The technologies disclosed in JP2016-091424A, JP6257147B, and JP2016-046627A are known. In addition, a system in which an image output apparatus outputs an image of a target file registered in, for example, a server apparatus is also known hitherto.

Aspects of non-limiting embodiments of the present disclosure relate to an image output system, a server apparatus, and a non-transitory computer readable medium storing a program in which an image output apparatus is capable of outputting an image of a target file even though a user does not input information for specifying the target file for an image output to the image output apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image output system which includes a section that manages identification information for identifying a terminal apparatus and a target file as a target of an image output in correlation with each other, a section that acquires identification information of the terminal apparatus and designation information for designating an image output apparatus from the terminal apparatus, and a section that transmits the target file correlated with the identification information of the terminal apparatus, which has been acquired from the terminal apparatus to the image output apparatus designated by the designation information acquired from the terminal apparatus.

### BRIEF DESCRIPTION OF THE DRAWINGS

Exemplary embodiment(s) of the present invention will be described in detail based on the following figures, wherein:

FIG. 1 is a diagram illustrating a specific example of an image output system;

FIG. 2 is a diagram illustrating a specific example of a server apparatus;

FIG. 3 is a diagram illustrating a specific example of a portable terminal apparatus;

FIG. 4 is a diagram illustrating a specific example of an image output apparatus;

FIG. 5 is a diagram illustrating Specific Example 1 of processing when a file is registered;

FIG. 6 is a diagram illustrating a specific example of a content list;

FIG. 7 is a diagram illustrating Specific Example 2 of the processing when the file is registered;

FIG. 8 is a diagram illustrating a specific example of a management table of a reservation number;

FIG. 9 is a diagram illustrating Specific Example 3 of the processing when the file is registered; and

FIG. 10 is a diagram illustrating a specific example of processing when an image is output.

### DETAILED DESCRIPTION

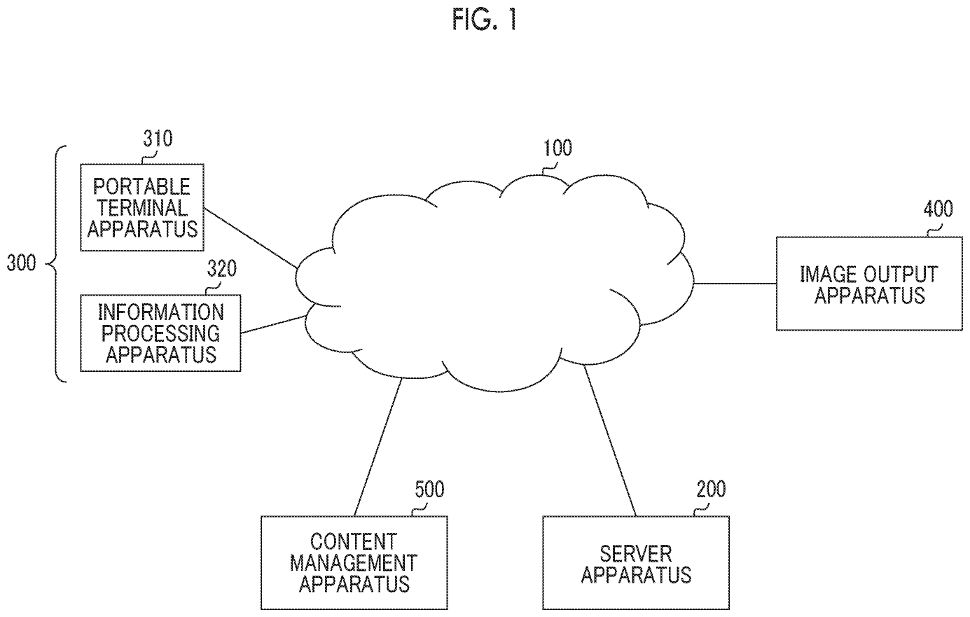

FIG. 1 is a diagram illustrating an example of a specific exemplary embodiment of the present invention. FIG. 1 illustrates a specific example of an image output system which includes a server apparatus 200, a user apparatus 300, an image output apparatus 400, and a content management apparatus 500. In the specific example illustrated in FIG. 1, the server apparatus 200, the user apparatus 300, the image output apparatus 400, and the content management apparatus 500 are connected to each other, for example, via a communication line 100 using at least one of a wireless communication or a wired communication, so as to transmit and receive data (information) to and from each other.

The server apparatus 200 manages a target file as a target of an image output. For example, the server apparatus 200 stores and manages the target file registered from a user via the user apparatus 300. For example, content managed by the content management apparatus 500 may be registered in the server apparatus 200 as the target file.

The user apparatus 300 is an apparatus used by a user of the image output system illustrated in FIG. 1. FIG. 1 illustrates a portable terminal apparatus 310 such as a smart phone or a tablet terminal and an information processing apparatus 320 such as a personal computer, as a specific example of the user apparatus 300.

The image output apparatus 400 outputs an image (including an image of only text or only symbols) of a target file corresponding to an output request from a user. One of specific examples of the image output apparatus 400 is a multifunction type apparatus including plural image output functions (at least one function of a printing function, a scanner function, a copying function, a facsimile function, and the like). For example, in a case where the image output apparatus 400 is a multifunction type apparatus, the image output apparatus 400 may be installed in a store such as a convenience store and be used by an unspecified number of customers. The image output apparatus 400 may be installed at a company, a school, or the like and be used by customers of the company or the school. The image output apparatus 400 may be an apparatus including only one function of the plural image output functions.

The content management apparatus 500 stores and manages plural kinds of content such as image files. The content managed by the content management apparatus 500 may be provided from, for example, a creator (including the organization such as a company) of the content.

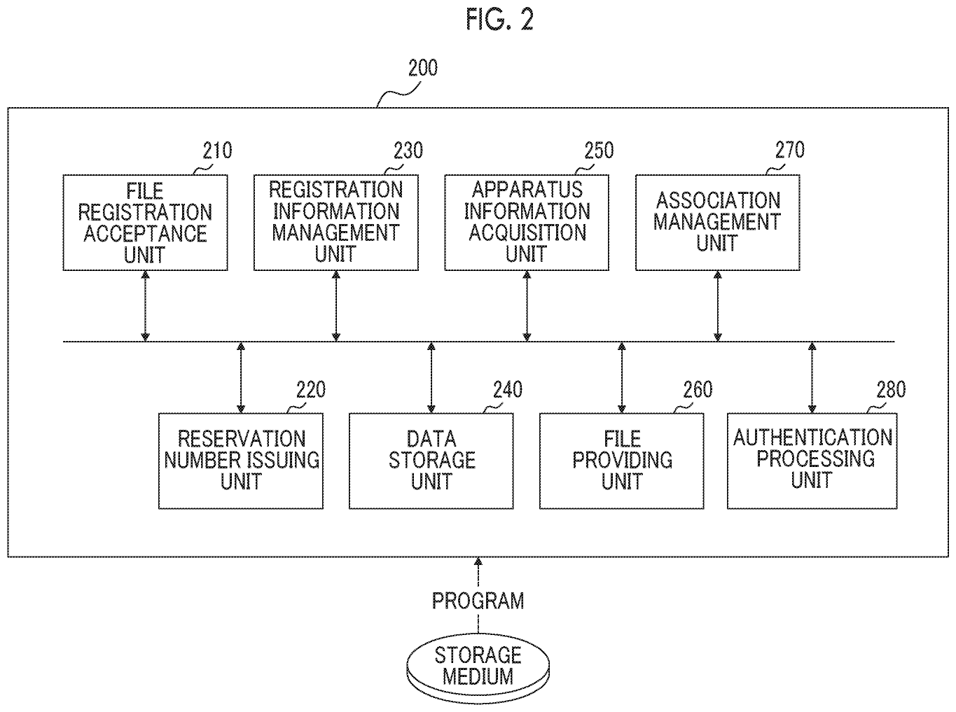

FIG. 2 is a diagram illustrating a specific example of the server apparatus 200 (FIG. 1). In the specific example illustrated in FIG. 2, the server apparatus 200 includes a file registration acceptance unit 210, a reservation number issuing unit 220, a registration information management unit 230, a data storage unit 240, an apparatus information acquisition unit 250, a file providing unit 260, an association management unit 270, and an authentication processing unit 280.

The file registration acceptance unit 210 accepts registration of a target file as a target of an image output. The file registration acceptance unit 210 accepts registration of a target file in a manner of receiving, for example, the target file which is obtained by being transmitted from the user apparatus 300 via the communication line 100, by a communication device or the like. The file registration acceptance unit 210 may receive, for example, content obtained from the content management apparatus 500 via the communication line 100, by the communication device or the like, and then may accept the received content as the target file.

The reservation number issuing unit 220 issues a reservation number of the target file of which the registration has been accepted by the file registration acceptance unit 210. The reservation number issuing unit 220 generates a reservation number unique to a specific target file, in order to uniquely distinguish the specific target file from plural target files, for example.

The registration information management unit 230 manages identification information for identifying a user apparatus 300 and a target file, in correlation with each other. The registration information management unit 230 manages, for example, registration information in which identification information of a portable terminal apparatus 310 used by a user and a reservation number of a target file registered by the user have been correlated with each other. For example, the registration information is stored in the data storage unit 240 and is managed by the registration information management unit 230.

The data storage unit 240 stores the registration information managed by the registration information management unit 230. The data storage unit 240 may store various kinds of data used by the server apparatus 200. The data storage unit 240 may be realized, for example, by using a storage device such as a hard disk drive or a semiconductor memory.

The apparatus information acquisition unit 250 acquires identification information of a portable terminal apparatus 310 and designation information for designating an image output apparatus 400, from the portable terminal apparatus 310. For example, the apparatus information acquisition unit 250 receives and acquires the identification information and the designation information obtained by being transmitted from the portable terminal apparatus 310 via the communication line 100, by a communication device or the like.

The file providing unit 260 provides a target file correlated with the identification information acquired from the portable terminal apparatus 310, for the image output apparatus 400 designated by the designation information acquired from the portable terminal apparatus 310. For example, the file providing unit 260 transmits data of the target file to the image output apparatus 400 by using the communication device or the like. The transmitted data of the target file is provided for the image output apparatus 400 via the communication line 100, for example.

The association management unit 270 manages associations between plural terminal apparatuses. For example, the association management unit 270 manages a portable terminal apparatus 310 and an information processing apparatus 320 of which an association with each other has been approved, in correlation with each other.

The authentication processing unit 280 performs authentication processing of a user requesting the authentication from the user apparatus 300 to the server apparatus 200. For example, the authentication processing unit 280 confirms log-in information (for example, an identifier and a password for log-in) obtained from a user apparatus 300, and determines whether or not a user using the user apparatus 300 is a registered user which has been registered in advance. For example, in a case where the user is the registered user, the user using the server apparatus 200 is permitted. In a case where the user is not the registered user, the user using the server apparatus 200 is prohibited.

The server apparatus 200 in the specific example illustrated in FIG. 2 may be realized by using one or more computers, for example. The computer includes hardware resources, for example, an arithmetic operational device such as a CPU, a storage device such as a memory or hard disk, a communication device using a communication line such as the Internet, a writing device that reads data from a storage medium such as an optical disk, a semiconductor memory, or a card memory and writes the data, and a display device such as a display, and an operation device that receives an operation from a user.

For example, the computer reads a program (software) corresponding to a function of at least one of plural components which are provided in the server apparatus 200 illustrated in FIG. 2 and are denoted by reference signs. At least a function of the server apparatus 200 illustrated in FIG. 2 is realized by the computer, in cooperation with the hardware resources of the computer and the read software. The program may be provided for the computer (server apparatus 200) via the communication line such as the Internet, for example. The program may be stored in a storage medium such as an optical disk, a semiconductor memory, or a card memory, and then be provided for the computer (server apparatus 200).

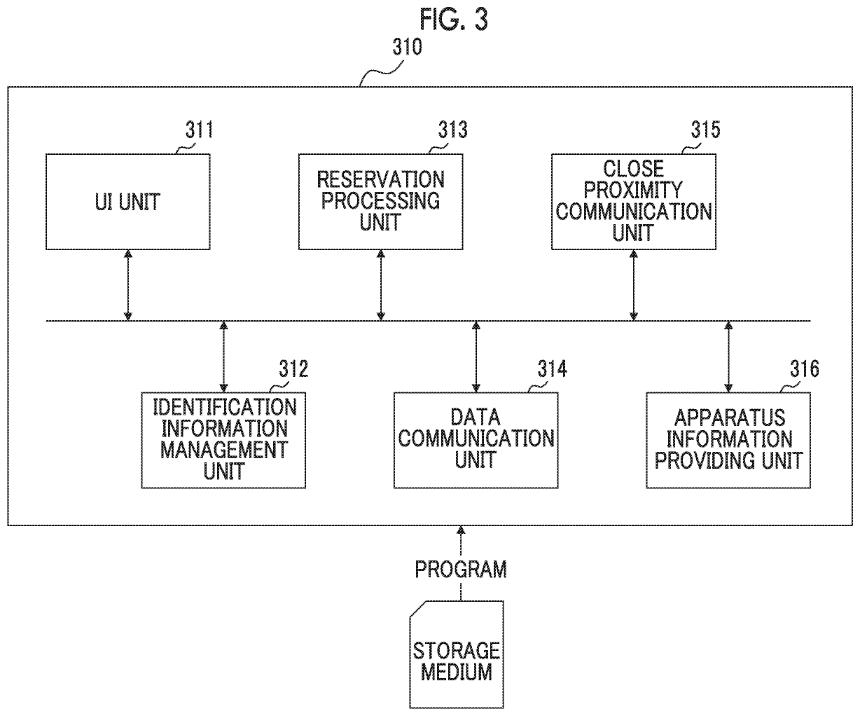

FIG. 3 is a diagram illustrating a specific example of the portable terminal apparatus 310 (FIG. 1). In the specific example illustrated in FIG. 3, the portable terminal apparatus 310 includes a user interface unit (UI unit) 311, an identification information management unit 312, a reservation processing unit 313, a data communication unit 314, a close proximity communication unit 315, and an apparatus information providing unit 316.

The user interface unit 311 functions as a user interface of a user using the portable terminal apparatus 310. For example, the user interface unit 311 provides the user of the portable terminal apparatus 310 with information for an operation by using an image, sound, and the like, and receives an operation from the user. For example, the user interface unit 311 may be realized by a display device such as a touch panel.

The identification information management unit 312 stores and manages identification information of a portable terminal apparatus 310. For example, the identification information management unit 312 stores and manages unique identification information (identifier of a portable terminal apparatus 310) assigned to the portable terminal apparatus 310, in order to uniquely distinguish the portable terminal apparatus 310 from plural apparatus (plural pieces of equipment).

The reservation processing unit 313 performs reservation processing of registering information in which the identification information of the portable terminal apparatus 310 and a target file have been correlated with each other, in the server apparatus 200. For example, the reservation processing unit 313 may register a reservation number of a target file (selected from plural kinds of content managed by the content management apparatus 500, by a user of a portable terminal apparatus 310) and identification information of the portable terminal apparatus 310 in the server apparatus 200 in correlation with each other.

The data communication unit 314 transmits and receives data to and from the server apparatus 200, the image output apparatus 400, the content management apparatus 500, or the like via the communication line 100. However, the close proximity communication unit 315 transmits and receives data to and from the image output apparatus 400 or the like in close proximity communication.

The close proximity communication unit 315 receives designation information for designating an image output apparatus 400, from the image output apparatus 400 in close proximity communication. The close proximity communication includes communication at a distance of about several centimeters to several tens of meters, for example. Specific examples of the close proximity communication performed by the close proximity communication unit 315 includes communications based on the standards of near-field communication (NFC), Bluetooth (registered trademark), Bluetooth low energy (BLE), and the like.

The apparatus information providing unit 316 provides the server apparatus 200 with the identification information of the portable terminal apparatus 310 and the designation information of the image output apparatus 400, which has been received in the close proximity communication. For example, the apparatus information providing unit 316 transmits the identification information of the portable terminal apparatus 310, which is managed by the identification information management unit 312 and the designation information of the image output apparatus 400, which has been received by the close proximity communication unit 315 in the close proximity communication, from the data communication unit 314 to the server apparatus 200. The transmitted data of the identification information and the designation information is provided for the server apparatus 200 via the communication line 100, for example.

The portable terminal apparatus 310 in the specific example illustrated in FIG. 3 may be realized by using a portable computer (including a portable information terminal such as a smart phone or a tablet), for example. The computer includes hardware resources as follows, for example: an arithmetic operational device such as a CPU; a storage device such as a memory; a communication device using a communication line such as the Internet; a writing device that reads data from a storage medium such as a semiconductor memory or a card-type storage medium and writes data; and a touch panel including a function of receiving an operation from a user and a function of displaying an image.

For example, the computer reads a program (software) of an application corresponding to a function of at least one of plural components which are provided in the portable terminal apparatus 310 illustrated in FIG. 3 and are denoted by reference signs. At least a function of the portable terminal apparatus 310 is realized by the computer, in cooperation with the hardware resources of the computer and the read software. The program may be provided for the computer (portable terminal apparatus 310) via the communication line such as the Internet, for example. The program may be stored in a storage medium such as a memory (including a card memory) using a semiconductor storage element and then be provided for the computer (portable terminal apparatus 310).

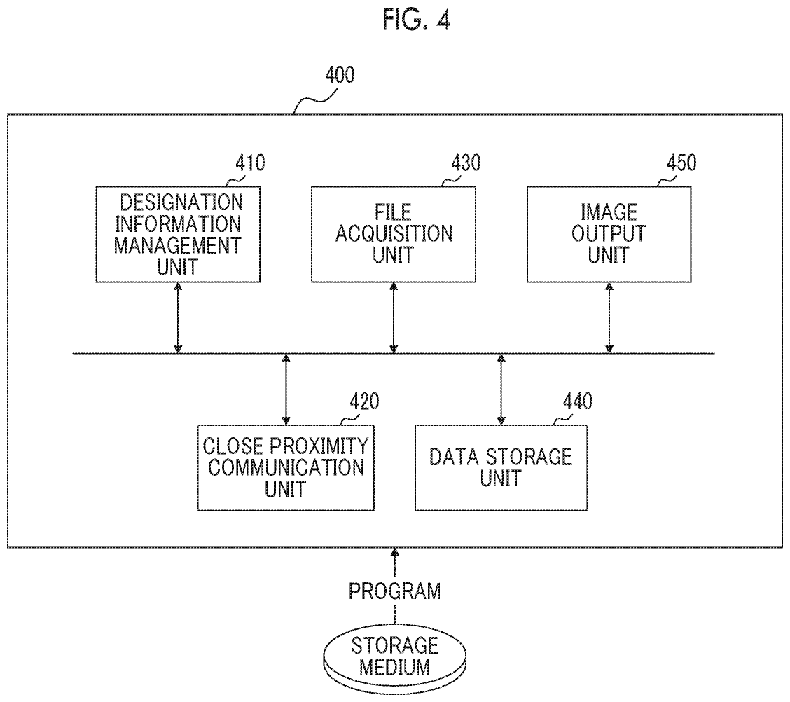

FIG. 4 is a diagram illustrating a specific example of the image output apparatus 400 (FIG. 1). In the specific example illustrated in FIG. 4, the image output apparatus 400 includes a designation information management unit 410, a close proximity communication unit 420, a file acquisition unit 430, a data storage unit 440, and an image output unit 450.

The designation information management unit 410 stores and manages the designation information of the image output apparatus 400. For example, the designation information management unit 410 manages unique designation information assigned to the image output apparatus 400, in order to uniquely distinguish the image output apparatus 400 from plural apparatus (plural pieces of equipment). For example, the designation information for designating an image output apparatus 400 may be used with information and the like of a store in which the image output apparatus 400 has been installed.

The close proximity communication unit 420 transmits the designation information of the image output apparatus 400 to the portable terminal apparatus 310 in close proximity communication. The close proximity communication includes communication at a distance of about several centimeters to several tens of meters, for example. Specific examples of the close proximity communication performed by the close proximity communication unit 420 include communications based on the standards of near-field communication (NFC), Bluetooth (registered trademark), Bluetooth low energy (BLE), and the like. For example, the close proximity communication unit 315 in the portable terminal apparatus 310 and the close proximity communication unit 420 in the image output apparatus 400 transmit and receive data to and from each other in close proximity communication corresponding to the same standards.

The file acquisition unit 430 acquires a target file transmitted from the server apparatus 200. For example, the file acquisition unit 430 acquires a target file in a manner of receiving the target file obtained by being transmitted from the server apparatus 200 via the communication line 100, by a communication device or the like. For example, the data storage unit 440 stores the target file acquired by the file acquisition unit 430.

Data of the target file acquired by the file acquisition unit 430 is stored in the data storage unit 440. The data storage unit 440 may store various kinds of data used by the image output apparatus 400. The data storage unit 440 may be realized, for example, by using a storage device such as a hard disk drive or a semiconductor memory.

The image output unit 450 outputs an image of the target file received and acquired by the file acquisition unit 430. The image output unit 450 performs the image output in accordance with an instruction from the user.

The image output apparatus 400 in the specific example illustrated in FIG. 4 may be realized by using one or more computers, for example. The computer includes hardware resources, for example, an arithmetic operational device such as a CPU, a storage device such as a memory or hard disk, a communication device using a communication line such as the Internet, a writing device that reads data from a storage medium such as an optical disk, a semiconductor memory, or a card memory and writes the data, and a display device such as a display, and an operation device that receives an operation from a user.

For example, the computer reads a program (software) corresponding to a function of at least one of plural components which are provided in the image output apparatus 400 illustrated in FIG. 4 and are denoted by reference signs. At least a function of the image output apparatus 400 illustrated in FIG. 4 is realized by the computer, in cooperation with the hardware resources of the computer and the read software. The program may be provided for the computer (image output apparatus 400) via the communication line such as the Internet, for example. The program may be stored in a storage medium such as an optical disk, a semiconductor memory, or a card memory, and then be provided for the computer (image output apparatus 400).

The entire configuration of the image output system (including the server apparatus 200 illustrated in FIG. 2, the portable terminal apparatus 310 illustrated in FIG. 3, and the image output apparatus 400 illustrated in FIG. 4) illustrated in FIG. 1 is described above. Next, a specific example of processing realized by the image output system in FIG. 1 will be described in detail. The reference signs in FIGS. 1 to 4 are used for the components illustrated in FIGS. 1 to 4, in the following descriptions.

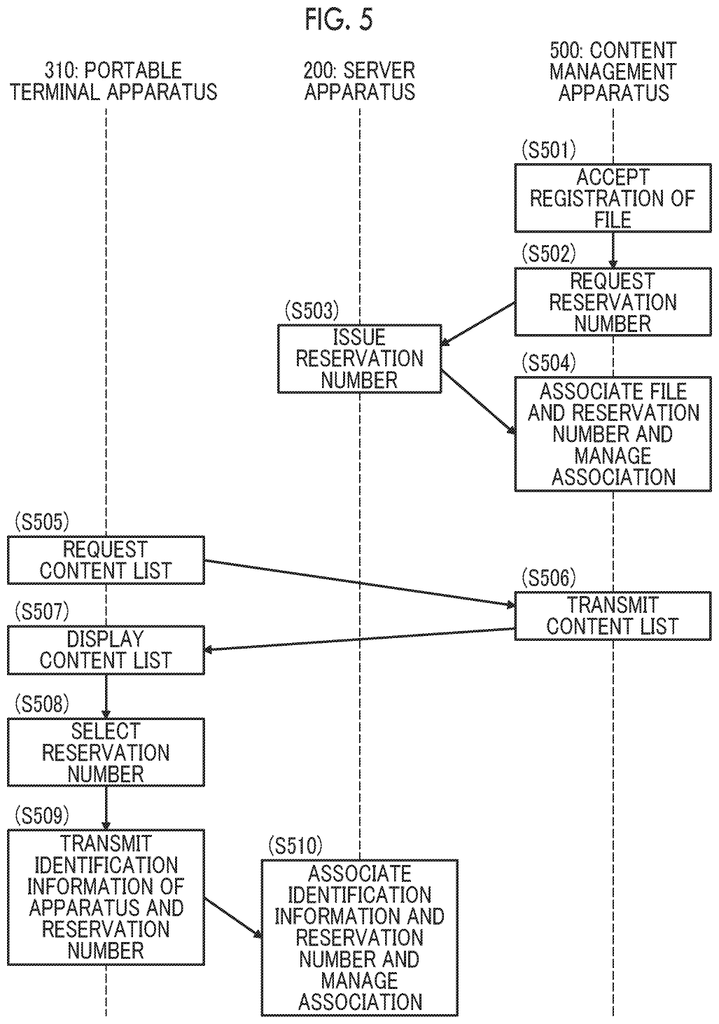

FIG. 5 is a diagram illustrating Specific Example 1 of processing when a file is registered. In Specific Example 1 illustrated in FIG. 5, a target file is selected from plural kinds of content stored and managed by the content management apparatus 500. In Specific Example 1 in FIG. 5, the content managed by the content management apparatus 500 is provided from, for example, a creator (including the organization such as a company) of the content.

In a case where the content management apparatus 500 accepts registration of a file of content from a creator (provider) of the content (S501), the content management apparatus 500 requests issuing of a reservation number to the server apparatus 200 (S502).

The reservation number issuing unit 220 in the server apparatus 200 issues the reservation number (S503). The content management apparatus 500 manages the file registered as the content and the reservation number corresponding to the file in association with each other (S504). For example, the content management apparatus 500 manages plural files registered as content and a reservation number of each of the files in correlation with each other.

A user using the content registered in the content management apparatus 500 requests a list of content managed by the content management apparatus 500, by using, for example, the portable terminal apparatus 310 (S505). The content list is transmitted from the content management apparatus 500 in response to the request (S506). Then, for example, the content list is displayed in a portable terminal apparatus 310 of the user having requested the list (S507).

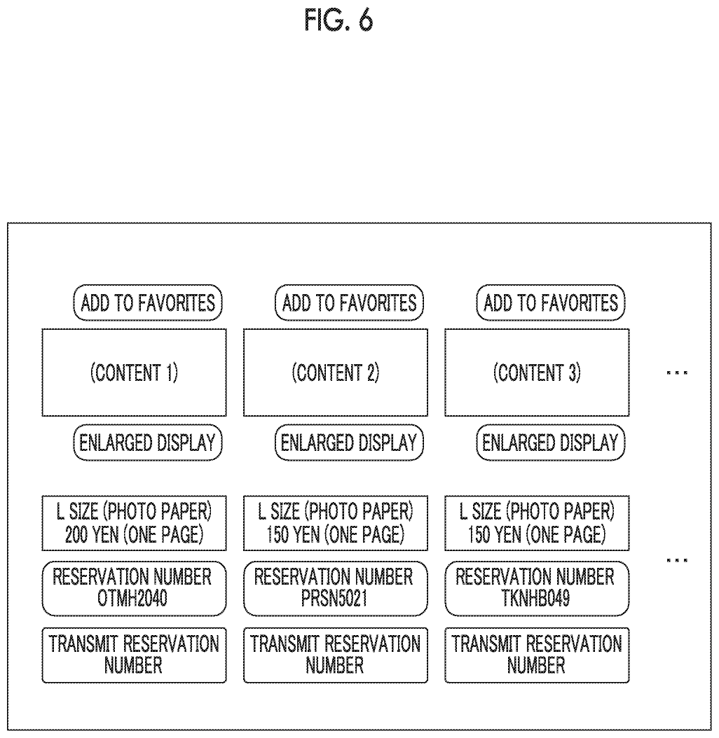

FIG. 6 is a diagram illustrating a specific example of the content list. FIG. 6 illustrates a specific example of a content list which is transmitted from the content management apparatus 500 and is provided for the portable terminal apparatus 310 of the user. The content list illustrated in FIG. 6 may be displayed in the user interface unit 311 of the portable terminal apparatus 310, for example.

Regarding the content list, a list of plural kinds of content usable by the user is provided. FIG. 6 illustrates a specific example of a content list including Content 1, Content 2, and Content 3. In the content list, for example, related information of the size, the fee, the reservation number, and the like of each content is displayed along with an image (for example, contracted sample image).

A user operates the button of “enlarged display” correlated with an image of each content, and thereby the image of each content may be enlarged-displayed. The user operates the button of “adding to favorites” correlated with the image of each content, and thereby the image of each content may be added to the favorites of the user.

For example, the user sees the content list displayed in the user interface unit 311 of the portable terminal apparatus 310 and recognizes content desired to be selected as a target file. For example, the user operates the button of “transmitting a reservation number” corresponding to the content desired to be selected as the target file, and thereby the reservation number of the content is selected.

Returning to FIG. 5, in a case where the user selects the reservation number of the content (S508), the portable terminal apparatus 310 transmits identification information of the portable terminal apparatus 310, which is managed by the identification information management unit 312, and the reservation number of the selected content to the server apparatus 200 (S509). The server apparatus 200 manages the identification information of the portable terminal apparatus 310 and the reservation number of the content as the target file, in association with each other (S510).

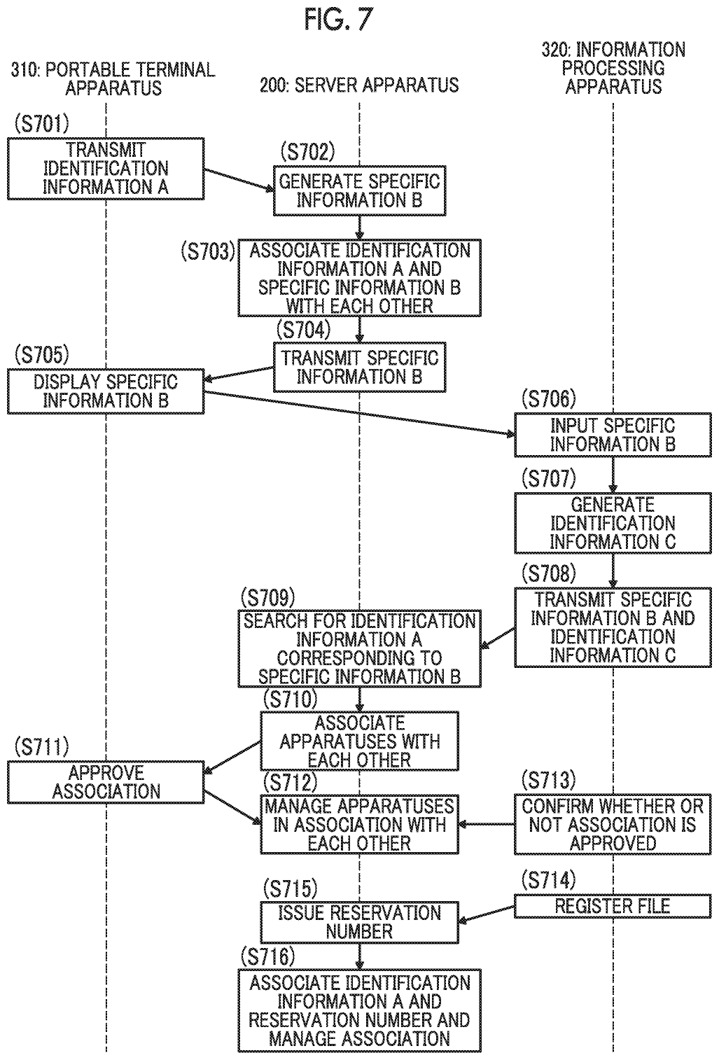

FIG. 7 is a diagram illustrating Specific Example 2 of the processing when a file is registered. In Specific Example 2 illustrated in FIG. 7, a target file from an information processing apparatus 320 of which an association with a portable terminal apparatus 310 has been approved is registered in the server apparatus 200. In Specific Example 2 illustrated in FIG. 7, the association of the portable terminal apparatus 310 and the information processing apparatus 320 with each other is approved by a user.

Firstly, identification information A is transmitted from a portable terminal apparatus 310 of a user to the server apparatus 200 (S701). For example, the portable terminal apparatus 310 transmits the identification information A of the portable terminal apparatus 310, which is managed by the identification information management unit 312, in accordance with an instruction from the user.

The server apparatus 200 which has received the identification information A generates specific information B for specifying the portable terminal apparatus 310 (S702). For example, the server apparatus 200 generates specific information B unique to the portable terminal apparatus 310, from the identification information A in accordance with a predetermined algorithm. The server apparatus 200 manages the identification information A and the specific information B in association with each other (S703), and transmits the specific information B to the portable terminal apparatus 310 (S704).

The portable terminal apparatus 310 which has received the specific information B displays the specific information B in the user interface unit 311, for example (S705). The user of the portable terminal apparatus 310 which has recognized the display of the specific information B inputs the specific information B to the information processing apparatus 320 used by the user (S706). The user may input the specific information B on a file registration screen displayed in a browser of the information processing apparatus 320, for example.

In a case where the specific information B is input, the information processing apparatus 320 generates identification information C for identifying the information processing apparatus 320 (S707). The information processing apparatus 320 may generate a globally unique identifier (GUID) as a specific example of the identification information C, for example, by using JavaScript (registered trademark) in the browser. The information processing apparatus 320 transmits the specific information B obtained from the user and the identification information C generated by the information processing apparatus 320, to the server apparatus 200 (S708).

In a case where the specific information B and the identification information C are transmitted, the server apparatus 200 searches for the identification information A managed in association with the specific information B (S709). For example, the server apparatus 200 searches for the identification information A managed in association with the specific information B, from plural pieces of identification information regarding plural portable terminal apparatuses 310 used by plural user.

The server apparatus 200 associates the searched identification information A (portable terminal apparatus 310) and the received identification information C (information processing apparatus 320) with each other (S710), and transmits information for inquiring whether or not to approve the association, to the portable terminal apparatus 310. Thus, for example, a display screen of inquiring of the user whether or not the portable terminal apparatus 310 and the information processing apparatus 320 are associated with each other is displayed in the user interface unit 311 of the portable terminal apparatus 310.

For example, the user of the portable terminal apparatus 310 recognizes the display screen displayed in the user interface unit 311, and performs an operation of approving the association of the portable terminal apparatus 310 and the information processing apparatus 320 used by the user with each other (S711).

In a case where the server apparatus 200 accepts the approval of the association from the portable terminal apparatus 310, the server apparatus 200 manages the identification information A (portable terminal apparatus 310) and the identification information C (information processing apparatus 320) of which the association has been approved by the user, in association with each other (S712). For example, the association management unit 270 in the server apparatus 200 manages the portable terminal apparatus 310 and the information processing apparatus 320 of which the association has been approved, in correlation with each other.

The information processing apparatus 320 may confirm whether or not the association has been approved, to the server apparatus 200 (S713). For example, the information processing apparatus 320 may confirm whether or not the association has been approved, to the server apparatus 200 by polling.

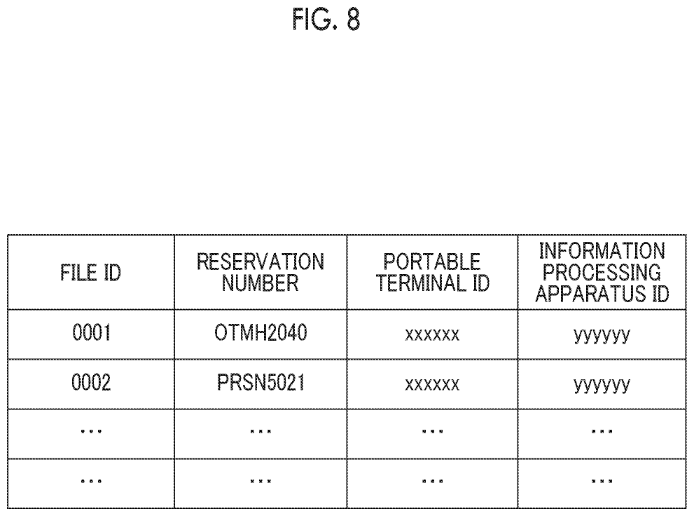

In this manner, the association of the portable terminal apparatus 310 and the information processing apparatus 320, which has been approved by the user is managed by the server apparatus 200. In a case where the user registers a target file in the server apparatus 200 by using the information processing apparatus 320 (S714), the reservation number issuing unit 220 in the server apparatus 200 issues a reservation number (S715). The registration information management unit 230 in the server apparatus 200 manages the reservation number of the target file registered by the information processing apparatus 320 and the identification information A of the portable terminal apparatus 310 associated with the information processing apparatus 320, in correlation with each other (S716). The registration information management unit 230 may manage a reservation number management table (FIG. 8), for example.

According to Specific Example 2 illustrated in FIG. 7, the association of the portable terminal apparatus 310 and the information processing apparatus 320 with each other is approved by the user. According to Specific Example 2 illustrated in FIG. 7, the target file is registered in the server apparatus 200 by the information processing apparatus 320 of which the association with the portable terminal apparatus 310 has been approved.

FIG. 8 is a diagram illustrating a specific example of the reservation number management table. FIG. 8 illustrates the specific example of the reservation number management table managed to correlate a file ID, a reservation number, a portable terminal ID, and an information processing apparatus ID with each other.

In the specific example illustrated in FIG. 8, the file ID is an identifier of the registered target file, and the reservation number is a reservation number of the registered target file. In the specific example illustrated in FIG. 8, the portable terminal ID and the information processing apparatus ID are identification information of the portable terminal apparatus 310 and the information processing apparatus 320 of which the association with each other has been approved. For example, the registration information management unit 230 may manage the reservation number management table in the specific example illustrated in FIG. 8.

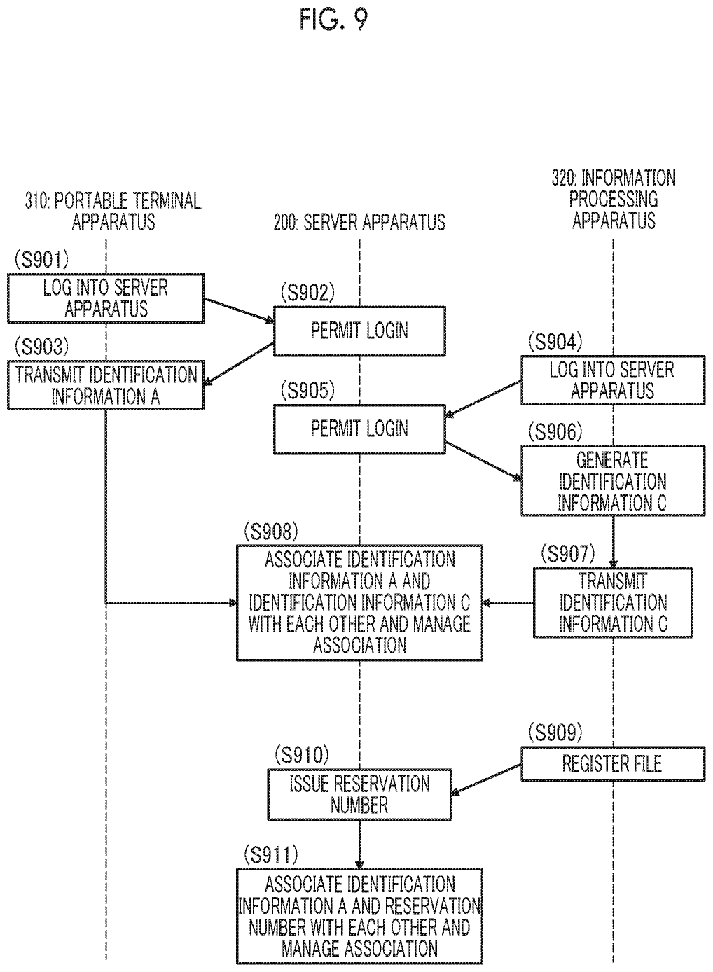

FIG. 9 is a diagram illustrating Specific Example 3 of the processing when a file is registered. In Specific Example 3 illustrated in FIG. 9, the association of the portable terminal apparatus 310 and the information processing apparatus 320 with each other is approved by the server apparatus 200. In addition, the target file is registered in the server apparatus 200 by the information processing apparatus 320 of which the association with the portable terminal apparatus 310 has been approved.

In Specific Example 3 illustrated in FIG. 9, a user using the portable terminal apparatus 310 requests the authentication from the portable terminal apparatus 310 to the server apparatus 200 (S901). For example, log-in information (for example, identifier and password for log-in) is transmitted from the portable terminal apparatus 310 of the user to the server apparatus 200.

For example, the authentication processing unit 280 in the server apparatus 200 confirms the log-in information obtained from the portable terminal apparatus 310, and determines whether or not the user using the portable terminal apparatus 310 is a registered user which has been registered in advance. For example, in a case where the user is the registered user, logging into the server apparatus 200 by the user is permitted (S902).

In a case where the log-in is permitted, identification information A is transmitted from the portable terminal apparatus 310 to the server apparatus 200 (S903). For example, the portable terminal apparatus 310 transmits the identification information A of the portable terminal apparatus 310 managed by the identification information management unit 312.

Further, in Specific Example 3 illustrated in FIG. 9, a user using the information processing apparatus 320 requests the authentication from the information processing apparatus 320 to the server apparatus 200 (S904). For example, log-in information (for example, identifier and password for log-in) is transmitted from the information processing apparatus 320 of the user to the server apparatus 200.

For example, the authentication processing unit 280 in the server apparatus 200 confirms the log-in information obtained from the information processing apparatus 320, and determines whether or not the user using the information processing apparatus 320 is a registered user which has been registered in advance. For example, in a case where the user is the registered user, logging into the server apparatus 200 by the user is permitted (S905).

In a case where the log-in is permitted, the information processing apparatus 320 generates identification information C for identifying the information processing apparatus 320 (S906). The information processing apparatus 320 may generate a globally unique identifier (GUID) as a specific example of the identification information C, for example, by using JavaScript (registered trademark) in the browser. The information processing apparatus 320 transmits the generated identification information C to the server apparatus 200 (S907).

In a case where the identification information A of the portable terminal apparatus 310 and the identification information C of the information processing apparatus 320 are transmitted, the server apparatus 200 manages the identification information A (portable terminal apparatus 310) and the identification information C (information processing apparatus 320) in association with each other (S908). For example, the association management unit 270 in the server apparatus 200 manages the portable terminal apparatus 310 and the information processing apparatus 320 of which the association has been approved, in correlation with each other.

In this manner, the association of the portable terminal apparatus 310 and the information processing apparatus 320, which has been approved by the authentication of the server apparatus 200 is managed by the server apparatus 200. For example, in a case where the user of the portable terminal apparatus 310 and the user of the information processing apparatus 320 are registered user satisfying a predetermined correspondence relationship, the server apparatus 200 may approve the association of the portable terminal apparatus 310 and the information processing apparatus 320.

For example, in a case where the user of the portable terminal apparatus 310 and the user of the information processing apparatus 320 are the registered users identical to each other, the server apparatus 200 approves the association of the portable terminal apparatus 310 and the information processing apparatus 320 with each other. For example, in a case where the user of the portable terminal apparatus 310 and the user of the information processing apparatus 320 are registered user belonging to the same group, the server apparatus 200 may approve the association of the portable terminal apparatus 310 and the information processing apparatus 320 with each other. For example, in a case where the user of the portable terminal apparatus 310 and the user of the information processing apparatus 320 are registered users of which a combination has been permitted in advance, the server apparatus 200 may approve the association of the portable terminal apparatus 310 and the information processing apparatus 320 with each other.

In a case where the association of the portable terminal apparatus 310 and the information processing apparatus 320 with each other is managed by the server apparatus 200, and the user registers the target file in the server apparatus 200 by using the information processing apparatus 320 (S909), the reservation number issuing unit 220 in the server apparatus 200 issues a reservation number (S910). The registration information management unit 230 in the server apparatus 200 manages the reservation number of the target file registered by the information processing apparatus 320 and the identification information A of the portable terminal apparatus 310 associated with the information processing apparatus 320, in correlation with each other (S911). The registration information management unit 230 may manage the reservation number management table (FIG. 8), for example.

According to Specific Example 3 illustrated in FIG. 9, the association of the portable terminal apparatus 310 and the information processing apparatus 320 with each other is approved by the server apparatus 200. In addition, according to Specific Example 3 illustrated in FIG. 9, the target file is registered in the server apparatus 200 by the information processing apparatus 320 of which the association with the portable terminal apparatus 310 has been approved.

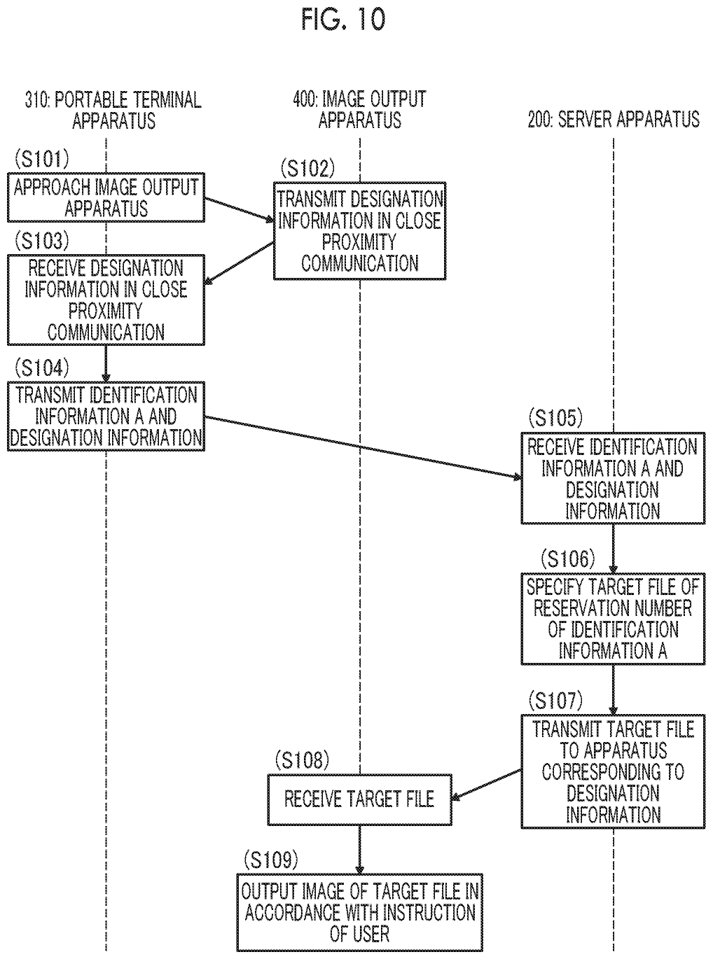

FIG. 10 is a diagram illustrating a specific example of processing when an image is output. The user who desires the image output apparatus 400 to output the target file registered in the server apparatus 200 goes to the place in which the image output apparatus 400 has been installed, with holding the portable terminal apparatus 310.

In a case where the portable terminal apparatus 310 of the user approaches the image output apparatus 400 (S101), the close proximity communication unit 420 in the image output apparatus 400 transmits the designation information for designating the image output apparatus 400, to the portable terminal apparatus 310 in close proximity communication (S102). The close proximity communication unit 315 in the portable terminal apparatus 310 receives the designation information of the image output apparatus 400 in the close proximity communication (S103).

The close proximity communication between the portable terminal apparatus 310 and the image output apparatus 400 includes communication at a distance of about several centimeters to several tens of meters, for example. Specific examples of the close proximity communication between the portable terminal apparatus 310 and the image output apparatus 400 include communications based on the standards of near-field communication (NFC), Bluetooth (registered trademark), Bluetooth low energy (BLE), and the like.

In a case where NFC is used for the close proximity communication between the portable terminal apparatus 310 and the image output apparatus 400, for example, the user holds the portable terminal apparatus 310 over an NFC communication device (NFC tag or the like) in the image output apparatus 400, and thus the designation information managed by the designation information management unit 410 in the image output apparatus 400 is transmitted to the portable terminal apparatus 310.

In a case where the portable terminal apparatus 310 received the designation information of the image output apparatus 400, the portable terminal apparatus 310 transmits the identification information A and the designation information to the server apparatus 200 (S104). For example, the apparatus information providing unit 316 in the portable terminal apparatus 310 provides the server apparatus 200 with the identification information A of the portable terminal apparatus 310 and the designation information of the image output apparatus 400, which has been received in the close proximity communication. For example, the apparatus information providing unit 316 transmits the identification information A managed by the identification information management unit 312 and the designation information of the image output apparatus 400, which has been received by the close proximity communication unit 315 in the close proximity communication, from the data communication unit 314 to the server apparatus 200. The transmitted data of the identification information and the designation information is provided for the server apparatus 200 via the communication line 100, for example.

In a case where the server apparatus 200 receives the identification information A and the designation information (S105), the server apparatus 200 specifies the target file having a reservation number correlated with the identification information A (S106). For example, the server apparatus 200 searches for and specifies the target file having a reservation number correlated with the identification information A, from plural files which are stored and managed by the data storage unit 240.

The server apparatus 200 transmits data of the target file specified in S106, to the image output apparatus 400 designated by the designation information received in S105 (S107). For example, the file providing unit 260 in the server apparatus 200 transmits the data of the target file to the image output apparatus 400 by using the communication device or the like. The transmitted data of the target file is provided for the image output apparatus 400 via the communication line 100, for example.

In a case where the data of the target file is transmitted from the server apparatus 200, the file acquisition unit 430 in the image output apparatus 400 receives and acquires the target file (S108). For example, the image output unit 450 in the image output apparatus 400 outputs an image of the target file in accordance with an instruction of an image output from the user (S109). For example, in a case where an instruction of an output by printing is performed as an instruction of the image output, the image output unit 450 performs outputting in a manner of printing the image of the target file on a medium such as paper. In this manner, the processing when the image is output, which is illustrated in FIG. 10 ends.

According to the specific example illustrated in FIG. 10, the image of the target file is output from the image output apparatus 400 by the user causing the portable terminal apparatus 310 to approach the image output apparatus 400, even though the user does not input the information for specifying the target file of the image output to an operation panel or the like of the image output apparatus 400.

Hitherto, the exemplary embodiment of the present invention is described. The exemplary embodiment is merely illustrative in all respects, and do not limit the scope of the present invention. The present invention encompasses various modifications without departing from the essence thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image output system comprising:
a section that manages identification information for identifying a terminal apparatus and a target file as a target of an image output, in correlation with each other;
a section that acquires identification information of the terminal apparatus and designation information for designating an image output apparatus from the terminal apparatus; and
a section that transmits the target file correlated with the identification information of the terminal apparatus, which has been acquired from the terminal apparatus, to the image output apparatus designated by the designation information acquired from the terminal apparatus.

2. An image output system comprising:
a terminal apparatus;
a server apparatus; and
an image output apparatus,
wherein the terminal apparatus includes
a receiving section that receives designation information for designating the image output apparatus from the image output apparatus in a close proximity communication, and
a transmission section that transmits identification information of the terminal apparatus and the designation information of the image output apparatus, which has been received in the close proximity communication, to the server apparatus,
the server apparatus includes
a management section that manages the identification information of the terminal apparatus and a target file for an image output, in correlation with each other, and
a transmission section that transmits the target file correlated with the identification information of the terminal apparatus, which has been acquired from the terminal apparatus, to the image output apparatus designated by the designation information acquired from the terminal apparatus, and
the image output apparatus includes
a transmission section that transmits the designation information of the image output apparatus to the terminal apparatus in the close proximity communication,
a receiving section that receives the target file transmitted from the server apparatus, and
an output section that outputs an image of the target file received by the receiving section.

3. A server apparatus comprising:
a management section that manages identification information for identifying a terminal apparatus and a target file as a target of an image output in correlation with each other;
a receiving section that receives the identification information of the terminal apparatus and designation information for designating an image output apparatus, from the terminal apparatus; and
a transmission section that transmits the target file correlated with the identification information of the terminal apparatus, which has been obtained from the terminal apparatus, to the image output apparatus designated by the designation information obtained from the terminal apparatus.

4. The server apparatus according to claim 3, further comprising:
an acceptance section that accepts registration of a target file from a second terminal apparatus having taken an approval of association with a first terminal apparatus,
wherein the management section manages identification information of the first terminal apparatus and the target file registered from the second terminal apparatus, in correlation with each other.

5. The server apparatus according to claim 3, further comprising:
a section that generates specific information for specifying the first terminal apparatus;
a section that transmits the specific information to the first terminal apparatus;
a section that receives the specific information which has been input to the second terminal apparatus by a user of the first terminal apparatus, from the second terminal apparatus;
a section that transmits information to the first terminal apparatus specified by the specific information received from the second terminal apparatus, the information being for inquiring whether or not to approve an association of the first terminal apparatus and the second terminal apparatus with each other; and
a section that accepts an approval of the association by the user of the first terminal apparatus, from the first terminal apparatus.

6. The server apparatus according to claim 4, further comprising:
a section that generates specific information for specifying the first terminal apparatus;
a section that transmits the specific information to the first terminal apparatus;
a section that receives the specific information which has been input to the second terminal apparatus by a user of the first terminal apparatus, from the second terminal apparatus;
a section that transmits information to the first terminal apparatus specified by the specific information received from the second terminal apparatus, the information being for inquiring whether or not to approve an association of the first terminal apparatus and the second terminal apparatus with each other; and
a section that accepts an approval of the association by the user of the first terminal apparatus, from the first terminal apparatus.

7. The server apparatus according to claim 3, further comprising:
a section that determines whether or not a first user requesting an authentication from the first terminal apparatus to the server apparatus is a registered user which has been registered in advance;
a section that determines whether or not a second user requesting an authentication from the second terminal apparatus to the server apparatus is a registered user which has been registered in advance; and
a section that approves the association of the first terminal apparatus and the second terminal apparatus with each other in a case where the first user and the second user are registered users satisfying a predetermined correspondence relationship.

8. The server apparatus according to claim 4, further comprising:
a section that determines whether or not a first user requesting an authentication from the first terminal apparatus to the server apparatus is a registered user which has been registered in advance;
a section that determines whether or not a second user requesting an authentication from the second terminal apparatus to the server apparatus is the registered user which has been registered in advance;
a section that approves the association of the first terminal apparatus and the second terminal apparatus with each other in a case where the first user and the second user are registered users satisfying a predetermined correspondence relationship.

9. The server apparatus according to claim 5, further comprising:
a section that determines whether or not a first user requesting an authentication from the first terminal apparatus to the server apparatus is a registered user which has been registered in advance;
a section that determines whether or not a second user requesting an authentication from the second terminal apparatus to the server apparatus is the registered user which has been registered in advance;
a section that approves the association of the first terminal apparatus and the second terminal apparatus with each other in a case where the first user and the second user are registered users satisfying a predetermined correspondence relationship.

10. The server apparatus according to claim 6, further comprising:
a section that determines whether or not a first user requesting an authentication from the first terminal apparatus to the server apparatus is a registered user which has been registered in advance;
a section that determines whether or not a second user requesting an authentication from the second terminal apparatus to the server apparatus is the registered user which has been registered in advance;
a section that approves the association of the first terminal apparatus and the second terminal apparatus with each other in a case where the first user and the second user are registered users satisfying a predetermined correspondence relationship.

11. A non-transitory computer readable medium storing a program causing a computer to realize:
a function of managing identification information for identifying a terminal apparatus and a target file as a target of an image output, in correlation with each other;
a function of acquiring the identification information of the terminal apparatus and designation information for designating an image output apparatus from the terminal apparatus; and
a function of providing the target file correlated with the identification information of the terminal apparatus, which has been obtained from the terminal apparatus, for the image output apparatus designated by the designation information obtained from the terminal apparatus.
